(19) United States
(12) Patent Application Publication
(10) Pub. No.: US 2024/0180059 A1
(43) Pub. Date: Jun. 6, 2024

(54) AGRICULTURAL SYSTEM AND METHOD FOR MONITORING THE PERFORMANCE OF AN AGRICULTURAL IMPLEMENT

(71) Applicant: CNH Industrial America LLC, New Holland, PA (US)

(72) Inventors: Brittany Schroeder, Bunker Hill, IN (US); Joshua D. Knoblauch, Lowpoint, IL (US)

(21) Appl. No.: 18/073,212

(22) Filed: Dec. 1, 2022

(51) Int. Cl. A01B 79/00; A01B 63/24; G01S 17/88

(52) U.S. Cl. CPC A01B 79/005; A01B 63/24; G01S 17/88

(57) ABSTRACT

An agricultural system for monitoring the performance of an agricultural implement includes an agricultural implement having at least one ground engaging tool, and one or more Light Detection and Ranging (LIDAR) sensors having a field of view directed toward a portion of the field worked by the agricultural implement during the agricultural operation. The sensor(s) generates first light at a first output frequency and second light at a second output frequency, with the first output frequency being different than the second output frequency, and generates first data indicative of reflection of the first light off the portion of the field and second data indicative of reflection of the second light off the portion of the field. Additionally, the system includes a computing system that determines a surface feature parameter of the portion of the field based at least in part on the first data and the second data.

### FIELD OF THE INVENTION

The present disclosure relates generally to agricultural implements and, more particularly, to monitoring the performance of an agricultural implement during an agricultural operation within a field.

### BACKGROUND OF THE INVENTION

It is well known that, to attain the best agricultural performance from a field, a farmer must cultivate the soil, typically through a tillage operation. Tillage implements typically include a plurality of ground engaging tools configured to engage the soil as the implement is moved across the field. Such ground engaging tool(s) loosen and/or otherwise agitate the soil to a certain depth in the field to prepare the field for subsequent agricultural operations, such as planting operations.

When performing a tillage operation, it is desirable to create a level and uniform layer of tilled soil across the field to form a proper seedbed in subsequent planting operations. Depending on the season, different surface finishes may be desired. For instance, rougher surfaces with more and/or larger clods may be desired when tilling before wintering a field, as the surface will become smoother over winter and be ready for spring planting, whereas a smoother field may crust over during wintering, which requires another tillage pass before spring planting to break up the crust. However, the soil type or texture, the amount and distribution of crop residue, the moisture content, and/or the like may vary across a field, which requires an operator to constantly monitor the surface finish created during passes with the implement during the agricultural operation, and make frequent adjustments to the implement to maintain the proper surface finish. Further, it may be difficult for an operator to see the field directly behind the implement if the implement is creating dust. If the proper surface finish is not maintained, additional passes in the field may be required, which increases costs and time, and may even reduce the yield of the next planting within the field.

Accordingly, a system and method for monitoring the performance of an agricultural implement during an agricultural operation with the agricultural implement would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural system for monitoring the performance of an agricultural implement. The agricultural system may include an agricultural implement having at least one ground engaging tool, where the at least one ground engaging tool may be configured to engage a field during an agricultural operation performed by the agricultural implement within the field. The system may further include one or more Light Detection and Ranging (LIDAR) sensors having a field of view directed toward a portion of the field worked by the agricultural implement during the agricultural operation, where the one or more LIDAR sensors may be configured to generate first light at a first output frequency and second light at a second output frequency, the first output frequency being different than the second output frequency, and where the one or more LIDAR sensors may be configured to generate first data indicative of reflection of the first light off the portion of the field and second data indicative of reflection of the second light off the portion of the field. Additionally, the system may include a computing system communicatively coupled to the one or more LIDAR sensors. The computing system may be configured to receive the first data generated by the one or more LIDAR sensors, receive the second data generated by the one or more LIDAR sensors, and determine a surface feature parameter of the portion of the field based at least in part on the first data and the second data.

In another aspect, the present subject matter is directed to a method for monitoring the performance of an agricultural implement, with the agricultural implement having at least one ground engaging tool configured to engage a field during an agricultural operation within the field. The method may include controlling, with a computing system, one or more Light Detection and Ranging (LIDAR) sensors to generate first light at a first output frequency and second light at a second output frequency, with the one or more LIDAR sensors having a field of view directed towards a portion of the field worked by the agricultural implement during the agricultural operation. The method may further include receiving, with the computing system, first data generated by the one or more LIDAR sensors, where the first data may be indicative of reflection of the first light off of the portion of the field. Moreover, the method may include receiving, with the computing system, second data generated by the one or more LIDAR sensors, where the second data may be indicative of reflection of the second light off of the portion of the field. Additionally, the method may include determining, with the computing system, a surface feature parameter of the portion of the field based at least in part on the first data and the second data.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a tillage implement coupled to a work vehicle in accordance with aspects of the present subject matter:

FIG. 2 illustrates another perspective view of the implement, particularly illustrating various components of the implement, in accordance with aspects of the present subject matter:

FIG. 3 illustrates a schematic view of a system for monitoring the performance of an agricultural implement during an agricultural operation with the agricultural implement in accordance with aspects of the present subject matter; and

FIG. 4 illustrates a flow diagram of one embodiment of a method for monitoring the performance of an agricultural implement during an agricultural operation with the agricultural implement in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to systems and methods for monitoring the performance of an agricultural implement during an agricultural operation with the agricultural implement. Specifically, the disclosed system may include an agricultural implement having at least one ground engaging tool (e.g., a shank, a disc blade, a leveling blade, a tine, a basket assembly, and/or the like) configured to engage and work a field during the agricultural operation. In accordance with aspects of the present subject matter, the system may further include one or more light detection and ranging (LIDAR) sensors having a field of view directed to a portion of the field worked by the implement (e.g., directed aft of the implement, directed towards a previous swath, and/or the like). The LIDAR sensor(s) may be multi-frequency LIDAR sensors configured to generate light at multiple frequencies, such as first light at a first frequency and second light at a second frequency, where the first and second frequencies interact differently with different materials. For instance, the first light at the first frequency may be reflected by clods, crop residue, and/or the like, whereas the second light at the second frequency may be reflected by clods, but not the crop residue and/or the like. A computing system of the disclosed system may be configured to receive first data generated by the LIDAR sensor(s) indicative of reflection of the first light off the portion of the worked area of the field and second data generated by the LIDAR sensor(s) indicative of reflection of the second light off the portion of the worked area, then determine a surface feature parameter of a surface of the portion of the field based at least in part on the first data and the second data, which in turn may be indicative of the performance of the implement.

For instance, the first data may indicate a surface profile of the field (created by clods, crop residue, soil, rocks, etc.), whereas the second data indicates at least one type of surface feature (e.g., clods, crop residue, soil, rocks, etc.) on the surface of the field. For example, the first data may indicate a surface profile of the surface of the field, whereas the second data may have voids indicating where crop residue is on the field. In such instance, subtracting the voids determined from the second data from the first data, for example, may indicate the location of clods. Thus, the computing system may be configured to determine surface feature parameters such as the surface roughness of the surface profile of the field, a levelness of the surface profile of the field, coverage and/or distribution of crop residue on the surface of the field, and/or a size and/or distribution of clods on the surface of the field based at least in part on the first data and the second data.

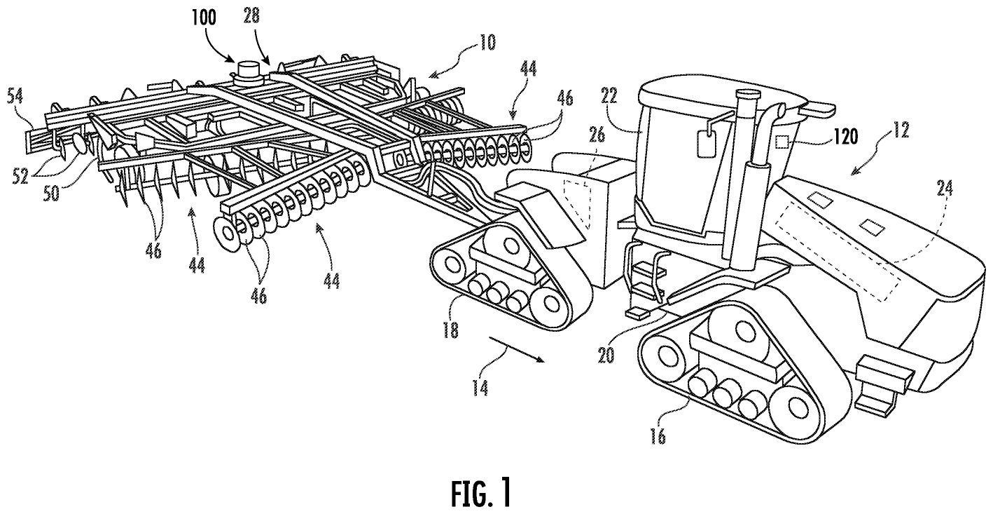

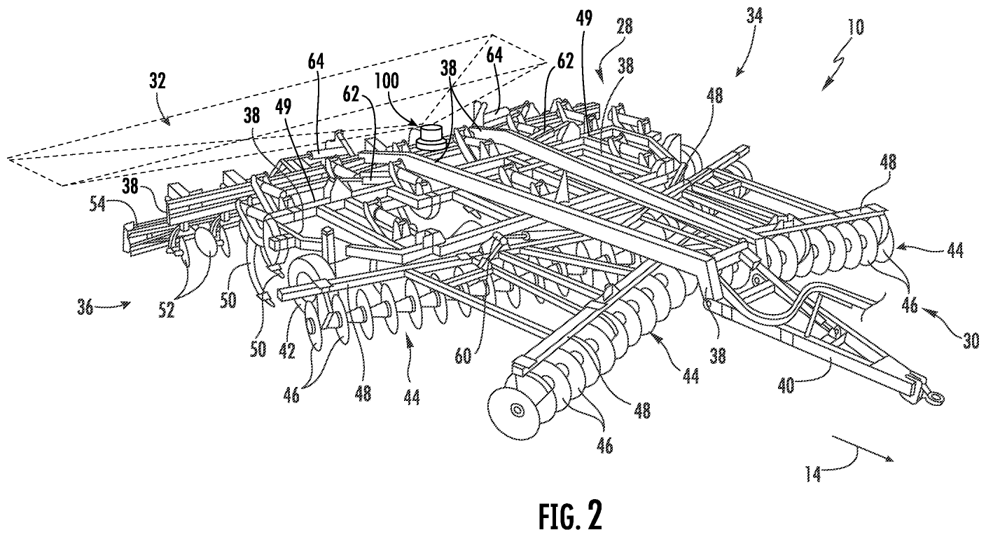

Referring now to the drawings, FIGS. 1 and 2 illustrate differing perspective views of one embodiment of an agricultural implement 10 in accordance with aspects of the present subject matter. Specifically, FIG. 1 illustrates a perspective view of the agricultural implement 10 coupled to a work vehicle 12. Additionally, FIG. 2 illustrates a perspective view of the implement 10, particularly illustrating various components of the implement 10.

In general, the implement 10 may be configured to be towed across a field in a direction of travel (e.g., as indicated by arrow 14) by the work vehicle 12. As shown, the implement 10 may be configured as a tillage implement, and the work vehicle 12 may be configured as an agricultural tractor. However, in other embodiments, the implement 10 may be configured as any other suitable type of implement, such as a seed-planting implement, a fertilizer-dispensing implement, and/or the like. Similarly, the work vehicle 12 may be configured as any other suitable type of vehicle, such as an agricultural harvester, a self-propelled sprayer, and/or the like.

As shown in FIG. 1, the work vehicle 12 may include a pair of front track assemblies 16, a pair or rear track assemblies 18, and a frame or chassis 20 coupled to and supported by the track assemblies 16, 18. An operator's cab 22 may be supported by a portion of the chassis 20 and may house various input devices (e.g., one or more user interfaces 120) for permitting an operator to control the operation of one or more components of the work vehicle 12 and/or one or more components of the implement 10. Additionally, as is generally understood, the work vehicle 12 may include an engine 24 and a transmission 26 mounted on the chassis 20. The transmission 26 may be operably coupled to the engine 24 and may provide variably adjusted gear ratios for transferring engine power to the track assemblies 16, 18 via a drive axle assembly (not shown) (or via axles if multiple drive axles are employed).

As shown in FIGS. 1 and 2, the implement 10 may include a frame 28. More specifically, as shown in FIG. 2, the frame 28 may extend longitudinally between a forward end 30 and an aft end 32. The frame 28 may also extend laterally between a first side 34 and a second side 36. In this respect, the frame 28 generally includes a plurality of structural frame members 38, such as beams, bars, and/or the like, configured to support or couple to a plurality of components. Furthermore, a hitch assembly 40 may be connected to the frame 28 and configured to couple the implement 10 to the work vehicle 12. Additionally, a plurality of wheels 42 (only one of which is shown in FIG. 2) may be coupled to the frame 28 to facilitate towing the implement 10 in the direction of travel 14.

In several embodiments, one or more ground engaging tools may be coupled to and/or supported by the frame 28. In such embodiments, the ground engaging tool(s) may, for example, include one or more ground-penetrating tools. More particularly, in certain embodiments, the ground engaging tools may include one or more disk blades 46 and/or one or more shanks 50 supported relative to the frame 28. In one embodiment, each disk blade 46 and/or shank 50 may be individually supported relative to the frame 28. Alternatively, one or more groups or sections of the ground engaging tools may be ganged together to form one or more ganged tool assemblies, such as the disk gang assemblies 44 shown in FIGS. 1 and 2.

As illustrated in FIG. 2, each disk gang assembly 44 includes a toolbar 48 coupled to the implement frame 28 and a plurality of disk blades 46 supported by the toolbar 48 relative to the implement frame 28. Each disk blade 46 may, in turn, be configured to penetrate into or otherwise engage the soil as the implement 10 is being pulled through the field. As is generally understood, the various disk gang assemblies 44 may be oriented at an angle relative to the direction of travel 14, such that an axis of rotation of the disks is not perpendicular to the direction of travel 14, to promote more effective tilling of the soil. However, it should be appreciated that the disk gang assemblies 44 may be oriented in any other suitable manner relative to the direction of travel 14. In the embodiment shown in FIGS. 1 and 2, the implement 10 includes four disk gang assemblies 44 supported on the frame 28 at a location forward of the shanks 50, adjacent to the forward end 30 of the implement 10, such as by including two forward disk gang assemblies 44 and two rear disk gang assemblies 44. However, it should be appreciated that, in alternative embodiments, the implement 10 may include any other suitable number of disk gang assemblies 44, such as more or fewer than four disk gang assemblies 44. Furthermore, in one embodiment, the disk gang assemblies 44 may be mounted to the frame 28 at any other suitable location, such as adjacent to the aft end 32 of the implement 10.

It should be appreciated that, in addition to the shanks 50 and the disk blades 46, the implement frame 28 may be configured to support any other suitable ground engaging tools. For instance, in the illustrated embodiment, the frame 28 is also configured to support a plurality of leveling blades 52 and rolling (or crumbler) basket assemblies 54.

Moreover, in several embodiments, the implement 10 may include a plurality of actuators configured to adjust the positions of the implement 10 and/or various ground engaging tools coupled thereto. For example, in some embodiments, the implement 10 may include a plurality of disk gang actuators 60 (one is shown in FIG. 2), with each actuator 60 being configured to move or otherwise adjust the orientation or position of one or more of the disk gang assemblies 44 relative to the implement frame 28. For example, a first end of each actuator 60 may be coupled to a toolbar 48 of the corresponding disk gang assembly 44, while a second end of each actuator 60 may be coupled to the frame 28. Each actuator 60 may be configured to extend and/or retract to adjust the angle of the corresponding disk gang assembly(ies) 44 relative to a lateral centerline (not shown) of the frame 28 and/or the penetration depth of the associated disk blades 46. Furthermore, each actuator 60 may be configured to extend and/or retract to adjust a downforce applied by the actuator(s) 60 to the disk gang assembly(ies) 44, and thus the disk blades 46.

Further, in some embodiments, the implement 10 may include a plurality of shank frame actuator(s) 62 (FIG. 2), with each actuator 62 being configured to move or otherwise adjust the orientation or position of one or more of the shanks 50 relative to the implement frame 28. For example, each actuator 62 may be coupled between a toolbar 49 supporting the shank(s) 50 and the implement frame 28. As such the actuator(s) 62 may be configured to extend and/or retract to adjust the position of the toolbar(s) 49 and, thus, a penetration depth of the associated shank(s) 50. Similarly, in some embodiments, the implement 10 may include a plurality of basket actuator(s) 64, with each actuator 64 being configured to move or otherwise adjust the orientation or position of one or more of the basket assemblies 54 relative to the implement frame 28. For example, each actuator 64 may be coupled between one or more of the basket assemblies 54 and the implement frame 28 and be configured to extend and/or retract to adjust an aggressiveness of the associated basket assembly(ies) 54.

In the illustrated embodiment, each actuator 60, 62, 64 corresponds to a fluid-driven actuator, such as a hydraulic or pneumatic cylinder. However, it should be appreciated that each actuator 60, 62, 64 may correspond to any other suitable type of actuator, such as an electric linear actuator. It should additionally be appreciated that the implement 10 may include any other suitable actuators for adjusting the position and/or orientation of the ground-engaging tools of the implement 10 relative to the ground and/or implement frame 28.

In accordance with aspects of the present subject matter, the implement 10 and/or the work vehicle 12 may be equipped with one or more sensors for monitoring the performance of the implement 10 during an agricultural operation (e.g., a tillage operation) performed with the implement 10. For instance, one or more LIDAR sensors 100 may be supported on the implement 10 and/or the work vehicle 12, with the LIDAR sensor(s) 100 being configured to generate data indicative of one or more surface feature parameters of the surface of the field worked by the implement 10, where each of the surface feature parameter(s), in turn, is indicative of the performance of the implement 10. For example, the LIDAR sensor(s) 100 are supported on the implement 10 and/or the work vehicle 12 such that the LIDAR sensor(s) 100 are spaced apart from and above a surface of the field during an agricultural operation with the implement 10 while having a field of view generally directed towards a portion of the field. In some embodiments, the field of view of each of the LIDAR sensor(s) 100 is directed towards a portion of the field that has already been worked by the implement 10 during the current agricultural operation. For instance, the field of view of the LIDAR sensor(s) 100 may be directed aft of the implement 10 relative to the direction of travel 14 along a current swath being worked by the implement 10 and/or towards another swath (e.g., a directly adjacent swath to the current swath) within the field that was previously worked by the implement 10 during the current agricultural operation. In some instances, the LIDAR sensor(s) 100 may be positioned proximate a rear end of the implement 10 relative to the direction of travel 14. However, it should be appreciated that the LIDAR sensor(s) 100 may instead, or additionally, be positioned at any other suitable location for generating data indicative of the performance of the implement 10. In some embodiments, the LIDAR sensor(s) 100 is a three-dimensional (3D) LIDAR sensor(s). However, in other embodiments, the LIDAR sensor(s) 100 is a two-dimensional (2D) LIDAR sensor(s).

In accordance with aspects of the present subject matter, the LIDAR sensor(s) 100 are configured to output multiple frequencies of light and detect the reflectance of the multiple frequencies off of the field. For instance, in some embodiments, each of the LIDAR sensor(s) 100 is a multi-frequency LIDAR sensor(s) configured to output multiple frequencies of light simultaneously. For instance, each LIDAR sensor 100 may output or generate first light at a first output frequency, second light at a second output frequency, third light at a third output frequency, and so on, simultaneously, where the output frequencies are different from each other (e.g., the first output frequency is different from the second output frequency, the second output frequency is different from the third output frequency, the first output frequency is different from the third output frequency, etc.). Each of the output frequencies of light may interact differently with different materials. For instance, certain output frequencies of light (e.g., the first light at the first output frequency) may reflect off of some surface feature types (e.g., crop residue, clods, rocks, etc. on the surface of the field and sometimes the surface of the field itself), whereas other output frequencies of light (e.g., the second light at the second output frequency) may reflect off only some of the same surface feature types (e.g., clods, rocks, etc. on the surface of the field and sometimes the surface of the field itself), but be absorbed or not reflected by others of the surface feature types (e.g., the crop residue on the surface of the field).

Thus, as will be described below in greater detail, the different frequencies of the LIDAR sensor(s) 100 may be used to identify different surface features (e.g., surface profile, residue, clods, and/or the like) of the field already worked by the implement 10, which may, in turn, be used to determine at least one surface feature parameter (e.g., surface roughness, surface levelness, crop residue coverage, crop residue distribution, clod sizes, clod distribution, and/or the like) where the surface feature parameter(s) may be used to determine the performance of the implement 10.

It should be appreciated that multiple, single-frequency LIDAR sensors may be used instead of a multi-frequency LIDAR sensor 100, where each single-frequency LIDAR sensor is configured to generate light at a different frequency from another single-frequency LIDAR sensor. For instance, a single multi-frequency LIDAR sensor may weigh less than, require fewer input ports to a computing system than, and cost less than multiple single-frequency LIDAR sensors. It further should be appreciated that the configuration of the implement 10 described above and shown in FIGS. 1 and 2 and the work vehicle 12 described above and shown in FIG. 1 is provided only to place the present subject matter in an exemplary field of use. Thus, it should be appreciated that the present subject matter may be readily adaptable to any manner of implement and work vehicle configuration.

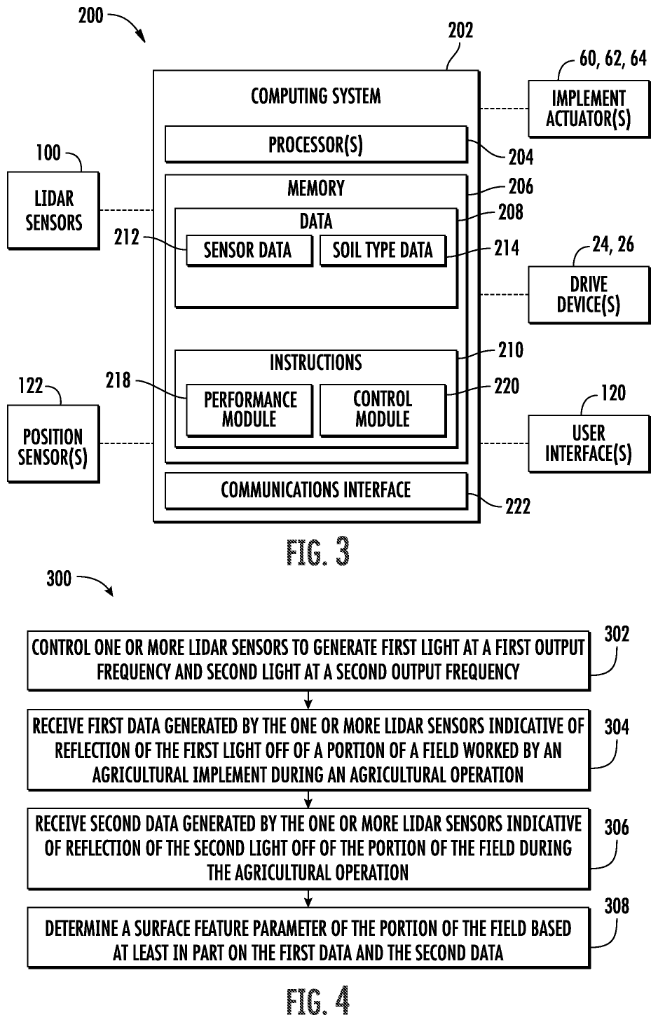

Referring now to FIG. 3, a schematic view is illustrated of one embodiment of a system 200 for monitoring the performance of an agricultural implement during an agricultural operation with the agricultural implement. In general, the system 200 will be described herein with reference to the implement 10 and vehicle 12 described above with reference to FIGS. 1 and 2. However, it should be appreciated that the disclosed system 200 may generally be utilized with any other suitable implement/vehicle combination having any other suitable implement/vehicle configuration. Additionally, it should be appreciated that, for purposes of illustration, communicative links or electrical couplings of the system 200 shown in FIG. 3 are indicated by dashed lines.

In several embodiments, the system 200 may include a computing system 202 and various other components configured to be communicatively coupled to and/or controlled by the computing system 202, such as LIDAR sensor(s) (e.g., the LIDAR sensor(s) 100 configured to generate data indicative of the performance of the implement 10), actuator(s) of the implement 10 (e.g., the implement actuator(s) 60, 62, 64), drive device(s) of the vehicle 12 (e.g., the engine 24, the transmission 26, etc.), and/or a user interface(s) (e.g., user interface(s) 120). The user interface(s) 120 described herein may include, without limitation, any combination of input and/or output devices that allow an operator to provide operator inputs to the computing system 202 and/or that allow the computing system 202 to provide feedback to the operator, such as a keyboard, keypad, pointing device, buttons, knobs, touch sensitive screen, mobile device, audio input device, audio output device, and/or the like. Additionally, the computing system 202 may be communicatively coupled to one or more position sensors 122 configured to generate data indicative of the location of the implement 10 and/or the vehicle 12, such as a satellite navigation positioning device (e.g., a GPS system, a Galileo positioning system, a Global Navigation satellite system (GLONASS), a BeiDou Satellite Navigation and Positioning system, a dead reckoning device, and/or the like).

In general, the computing system 202 may correspond to any suitable processor-based device(s), such as a computing device or any combination of computing devices. Thus, as shown in FIG. 3, the computing system 202 may generally include one or more processor(s) 204 and associated memory devices 206 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 206 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 206 may generally be configured to store information accessible to the processor(s) 204, including data 208 that can be retrieved, manipulated, created and/or stored by the processor(s) 204 and instructions 210 that can be executed by the processor(s) 204.

It should be appreciated that the computing system 202 may correspond to an existing computing device for the implement 10 or the vehicle 12 or may correspond to a separate processing device. For instance, in one embodiment, the computing system 202 may form all or part of a separate plug-in module that may be installed in operative association with the implement 10 or the vehicle 12 to allow for the disclosed system and method to be implemented without requiring additional software to be uploaded onto existing control devices of the implement 10 or the vehicle 12.

In several embodiments, the data 208 may be stored in one or more databases. For example, the memory 206 may include a sensor database 212 for storing data generated by the sensors 100, 122. For instance, the LIDAR sensor(s) 100 may be configured to continuously or periodically generate data associated with a portion of the field, such as during the performance of the agricultural operation with the implement 10. The data from the LIDAR sensor(s) 100 may be taken with reference to the position of the implement 10 and/or the vehicle 12 within the field based on the position data from the position sensor(s) 122. The data transmitted to the computing system 202 from the sensors 100, 122 may be stored within the sensor database 212 for subsequent processing and/or analysis. It should be appreciated that, as used herein, the term “sensor data 212” may include any suitable type of data received from the sensors 100, 122 that allows for the performance of the implement to be determined. For instance, the data generated by the LIDAR sensor(s) 100 may include reflectance data (e.g., as a point-cloud), and/or any other suitable type of data, and the data generated by the position sensor(s) 122 may include GPS coordinates, and/or any other suitable type of data.

Moreover, in some embodiments, the memory 206 may also include a soil type database 214 for storing field data indicative of the different soil types across a field. The field data stored in the soil type database 214 may include, for example, a soil type map indicating the soil type (e.g., established composition of silt, loam, clay, sand, etc., and/or texture) at each location within a field. The field data stored in the soil type database 214 may be generated and stored in the soil type database 214 before the performance of the agricultural operation with the agricultural implement 10. Soil type maps may be, for example, SSURGO maps, and/or any other suitable type of soil map. However, it should be appreciated that the field data may be stored in any other suitable format other than a soil type map, such as a lookup table, and/or the like.

The instructions 210 stored within the memory 206 of the computing system 202 may be executed by the processor(s) 204 to implement a performance module 218. In general, the performance module 218 may be configured to assess the sensor data 212 deriving from the sensors 100, 122 to determine the performance of the implement 10 during an agricultural operation with the implement 10 within a field. For instance, the performance module 218 may be configured to assess the sensor data 212 deriving from the sensors 100, 122 to determine one or more surface features (e.g., surface profile, residue, clod, and/or the like) and one or more parameters of such surface feature(s) (e.g., surface roughness, surface levelness, residue coverage, residue distribution, clod distribution, clod size, and/or the like) across the field, where the surface feature(s), particularly the parameter of the surface feature(s), is indicative of the performance of the implement 10.

For example, as indicated above, in one embodiment, first light generated by the LIDAR sensor(s) 100 at a first frequency (e.g., a shorter frequency) may be reflected by all of the surface features of the field within the field of view of the LIDAR sensor(s) 100. As such, the first data generated by the LIDAR sensor(s) 100 indicates the first light reflected and detected by LIDAR sensor(s) 100 and is indicative of the surface profile of the field, including any clods, residue, rocks, etc. on the surface of the field. Further, as indicated above, second light generated by the LIDAR sensor(s) 100 at a second frequency, different from the first frequency, (e.g., a longer frequency) may be reflected by only some of the surface features of the field within the field of view of the LIDAR sensor(s) 100. For instance, the second light may be absorbed by residue, but reflected by clods, rocks, and/or the like. As such, the second data generated by the LIDAR sensor(s) 100 indicates the second light reflected and detected by LIDAR sensor(s) 100 and is indicative of residue, which appears as voids as the second light is absorbed by the residue, and clods, rocks, and/or the like, which appears as the reflected light. It should be appreciated that the data corresponding to each frequency may be generated such that the data may be compared for a portion of the field. For instance, the first data and the second data may be generated simultaneously for the same portion of the field within the field of view of the sensor(s) 100 such that the first data and the second data may be directly compared.

The performance module 218 may be configured to determine surface feature parameter(s) of the surface feature(s) of the field from the first data and the second data. For instance, the performance module 218 may identify areas in the first data corresponding to the voids in the second data. For example, the performance module 218 may overlay the first data and the second data then determine surface feature(s) and surface feature parameter(s) based on the overlay. The voids from the second data overlaid onto the first data indicates the coverage (e.g., percentage of coverage) and the average size or thickness of the crop residue layer across the particular portion of the field within the field of view of the sensor(s) 100. Further, the difference in height between the surface profile from the first data and the surface profile from the second data at the void location indicates the size (e.g., height) and distribution of clods across the portion of the field within the field of view of the sensor(s) 100 from the areas that do not correspond to the residue. The performance module 218 may determine the overall surface roughness and/or surface levelness of the surface profile of the field based on the first data alone (e.g., including the crop residue and the clods), or may determine the roughness based on the overlay of the first data and the second data. The term “surface roughness” is intended to mean the texture of the surface profile whereas “surface levelness” is intended to mean the slope of the surface profile across a lateral width of the swath. It should be appreciated that, by using the first data and the second data together, a more dense point cloud may be generated than from the first data or the second data separately, which allows for better boundaries of residue and clods to be determined than can be determined from the first data or the second data separately, which improves determination of the different surface feature parameters. It should further be appreciated that the performance module 218 may identify the different surface features in any suitable order and/or may similarly identify the surface feature parameters in any suitable order.

It should additionally be appreciated that, in some embodiments, the performance module 218 may also be configured to control the LIDAR sensor(s) 100 to generate light at different frequencies and to generate the associated reflectance data. For instance, in some embodiments, the performance module 218 may determine the different frequencies at which the LIDAR sensor(s) 100 generate light simultaneously based at least in part on operator input(s) via the user interface(s) 120. For example, an operator may directly input the two or more frequencies for generating lights then the performance module 218 may control the LIDAR sensor(s) 100 according to such frequencies. However, in other instances, the control module 220 may use the data from the position sensor(s) 122 to determine the soil type from the soil type database 214 at the corresponding location within the field, then use known relationships between the soil type and reflectance properties (e.g., using look-up tables, suitable mathematical formulas, and/or algorithms which may also be stored in the soil type database 214 or otherwise accessible by the computing system 202) to determine the appropriate frequencies and either automatically control the LIDAR sensor(s) 100 according to such frequencies or suggest such frequencies to the operator via the user interface(s) 120.

Referring still to FIG. 3, in some embodiments, the instructions 210 stored within the memory 206 of the computing system 202 may also be executed by the processor(s) 204 to implement a control module 220. The control module 220 may generally be configured to initiate or perform a control action based on the performance of the implement 10. More particularly, the control module 220 may be configured to initiate or perform a control action based on the monitored surface feature parameters. For instance, the control module 220 may be configured to monitor the surface feature parameter(s) of the surface feature(s) determined based on the data generated by the LIDAR sensor(s) 100 relative to desired or predetermined surface feature parameter(s) of the monitored surface feature(s). The desired surface feature parameter(s) of the monitored surface features(s) may be input by an operator via the user interface(s) 120, predetermined based on a tillage prescription map uploaded and stored in the memory 206, or received/accessible in any other suitable manner. The control module 220 may initiate or perform a control action when the monitored surface feature parameter(s) of the surface feature(s) differs by or is outside of a given threshold from the desired surface feature parameter(s) of the monitored surface feature(s).

The control action, in one embodiment, includes adjusting the operation of one or more components of the implement 10, such as adjusting the operation of one or more of the actuators 60, 62, 64 to adjust the penetration depth of the ground engaging tool(s) 46, 50, 52, 54 and/or adjust the operation of one or more of the drive device(s) 24, 26 to adjust a ground speed of the implement 10 and/or the vehicle 12 based on the monitored surface feature parameter(s) (e.g., surface roughness, surface levelness, residue coverage, residue size, clod distribution, clod size, etc.) to improve performance of the implement 10. In some embodiments, the control action may include controlling the operation of the user interface 120 to notify an operator of the performance (e.g., the monitored surface feature parameter(s)) and/or the like. Additionally, or alternatively, in some embodiments, the control action may include adjusting the operation of the implement 10 based on an input from an operator, e.g., via the user interface 120.

Additionally, as shown in FIG. 3, the computing system 202 may also include a communications interface 222 to provide a means for the computing system 202 to communicate with any of the various other system components described herein. For instance, one or more communicative links or interfaces (e.g., one or more data buses) may be provided between the communications interface 222 and the sensor(s) 100, 122 to allow data transmitted from the sensor(s) 100, 122 to be received by the computing system 202. Similarly, one or more communicative links or interfaces (e.g., one or more data buses) may be provided between the communications interface 222 and the user interface 120 to allow operator inputs to be received by the computing system 202 and to allow the computing system 202 to control the operation of one or more components of the user interface 120. Moreover, one or more communicative links or interfaces (e.g., one or more data buses) may be provided between the communications interface 222 and the implement actuator(s) 60, 62, 64 and/or the drive device(s) 24, 26 to allow the computing system 202 to control the operation of one or more components of the implement actuator(s) 60, 62, 64 and/or the drive device(s) 24, 26.

Referring now to FIG. 4, a flow diagram of one embodiment of a method 300 for monitoring the performance of an agricultural implement during an agricultural operation with the agricultural implement is illustrated in accordance with aspects of the present subject matter. In general, the method 300 will be described herein with reference to the implement 10 and the work vehicle 12 shown in FIGS. 1-2, as well as the various system components shown in FIG. 3. However, it should be appreciated that the disclosed method 300 may be implemented with work vehicles and/or implements having any other suitable configurations, and/or within systems having any other suitable system configurations. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 4, at (302), the method 300 may include controlling one or more Light Detection and Ranging (LIDAR) sensors to generate first light at a first output frequency and second light at a second output frequency. For instance, as discussed above, the computing system 202 may be configured to control the operation of the LIDAR sensor(s) 100 to simultaneously generate first light at a first output frequency (e.g., a shorter frequency) and second light at a second output frequency (e.g., a longer frequency).

Further, at (304), the method 300 may include receiving first data generated by the one or more LIDAR sensors indicative of reflection of the first light off of a portion of a field worked by an agricultural implement during an agricultural operation. For example, as described above, the computing system 202 may be configured to receive first data generated by the LIDAR sensor(s) 100 indicative of reflection of the first light off of a portion of a field worked by the agricultural implement 10 during an agricultural operation (the portion of the field being within the field of view of the sensor(s) 100).

Moreover, at (306), the method 300 may include receiving second data generated by the one or more LIDAR sensors indicative of reflection of the second light off of the portion of the field during the agricultural operation. Similarly, as described above, the computing system 202 may be configured to receive second data generated by the LIDAR sensor(s) 100 indicative of reflection of the second light off of the portion of the field worked by the agricultural implement 10 during the agricultural operation (the portion of the field being within the field of view of the sensor(s) 100).

Additionally, at (308), the method 300 may include determining a surface feature parameter of the portion of the field based at least in part on the first data and the second data. For example, as discussed above, the computing system 202 may be configured to determine a surface feature parameter of one or more surface features of the portion of the field, such as a surface roughness of the surface profile, a levelness of the surface profile, crop residue coverage, crop residue size, clod distribution, clod size, and/or the like, based at least in part on the first data and the second data, with the surface feature parameter being indicative of the performance of the implement 10.

It is to be understood that the steps of the method 300 are performed by the computing system 202 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 202 described herein, such as the method 300, is implemented in software code or instructions which are tangibly stored on a tangible computer readable medium. The computing system 202 loads the software code or instructions via a direct interface with the computer readable medium or via a wired and/or wireless network. Upon loading and executing such software code or instructions by the computing system 202, the computing system 202 may perform any of the functionality of the computing system 202 described herein, including any steps of the method 300 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural system for monitoring the performance of an agricultural implement, the agricultural system comprising:
an agricultural implement having at least one ground engaging tool, the at least one ground engaging tool being configured to engage a field during an agricultural operation performed by the agricultural implement within the field;
one or more Light Detection and Ranging (LIDAR) sensors having a field of view directed toward a portion of the field worked by the agricultural implement during the agricultural operation, the one or more LIDAR sensors being configured to generate first light at a first output frequency and second light at a second output frequency, the first output frequency being different than the second output frequency, the one or more LIDAR sensors being configured to generate first data indicative of reflection of the first light off the portion of the field and second data indicative of reflection of the second light off the portion of the field; and
a computing system communicatively coupled to the one or more LIDAR sensors, the computing system being configured to:
receive the first data generated by the one or more LIDAR sensors;
receive the second data generated by the one or more LIDAR sensors; and
determine a surface feature parameter of the portion of the field based at least in part on the first data and the second data.

2. The agricultural system of claim 1, wherein the first data is further indicative of a surface profile of the portion of the field, and
wherein the second data is further indicative of a first surface feature type on a surface of the portion of the field.

3. The agricultural system of claim 1, wherein the first output frequency is reflected by a first surface feature type and a second surface feature type, the second surface feature type being different from the first surface feature type, and
wherein the second output frequency is reflected by the first surface feature type and absorbed by the second surface feature type.

4. The agricultural system of claim 3, wherein the first surface feature type comprises clods and the second surface feature type comprises crop residue.

5. The agricultural system of claim 1, wherein the computing system is configured to determine the surface feature parameter by comparing the first data to the second data.

6. The agricultural system of claim 1, wherein the surface feature parameter comprises at least one of clod size, clod distribution, crop residue coverage, or crop residue distribution.

7. The agricultural system of claim 1, wherein the one or more LIDAR sensors is a single multi-frequency LIDAR sensor configured to generate the first light and the second light simultaneously.

8. The agricultural system of claim 1, wherein the computing system is further configured to control an operation of the agricultural implement based at least in part on the surface feature parameter.

9. The agricultural system of claim 1, wherein the one or more LIDAR sensors comprises one or more three-dimensional (3D) LIDAR sensors.

10. The agricultural system of claim 1, wherein the agricultural implement is a tillage implement.

11. The agricultural system of claim 1, wherein the ground engaging tool comprises at least one of a shank, a disk blade, leveling blades, or a basket assembly.

12. A method for monitoring the performance of an agricultural implement, the agricultural implement having at least one ground engaging tool configured to engage a field during an agricultural operation within the field, the method comprising:
controlling, with a computing system, one or more Light Detection and Ranging (LIDAR) sensors to generate first light at a first output frequency and second light at a second output frequency, the one or more LIDAR sensors having a field of view directed towards a portion of the field worked by the agricultural implement during the agricultural operation;
receiving, with the computing system, first data generated by the one or more LIDAR sensors, the first data being indicative of reflection of the first light off of the portion of the field;
receiving, with the computing system, second data generated by the one or more LIDAR sensors, the second data being indicative of reflection of the second light off of the portion of the field; and
determining, with the computing system, a surface feature parameter of the portion of the field based at least in part on the first data and the second data.

13. The method of claim 12, wherein the first data is further indicative of a surface profile of the portion of the field, and
wherein the second data is further indicative of a first surface feature type on a surface of the portion of the field.

14. The method of claim 12, wherein the first output frequency is reflected by a first surface feature type and a second surface feature type, the second surface feature type being different from the first surface feature type, and
wherein the second output frequency is reflected by the first surface feature type and absorbed by the second surface feature type.

15. The method of claim 14, wherein the first surface feature type comprises clods and the second surface feature type comprises crop residue.

16. The method of claim 12, wherein determining the surface feature parameter comprises comparing the first data to the second data.

17. The method of claim 12, wherein the surface feature parameter comprises at least one of clod size, clod distribution, crop residue coverage, or crop residue distribution.

18. The method of claim 12, wherein controlling the one or more LIDAR sensors to generate the first light and the second light comprises controlling a single multi-frequency LIDAR sensor to generate the first light and the second light simultaneously.

19. The method of claim 12, further comprising controlling, with the computing system, an operation of the agricultural implement based at least in part on the surface feature parameter when the surface feature parameter is outside of a given threshold from a predetermined surface feature parameter.

20. The method of claim 19, wherein controlling the operation of the agricultural implement comprises at least one of controlling an actuator associated with the at least one ground engaging tool, adjusting a ground speed of the agricultural implement, or controlling a user interface associated with the agricultural implement.
